(19) United States
(12) Patent Application Publication
(10) Pub. No.: US 2018/0259635 A1
(43) Pub. Date: Sep. 13, 2018

(54) BROADBAND SENSING USING NARROWBAND FREQUENCY SAMPLING

(71) Applicant: Raytheon Company, Waltham, MA (US)

(72) Inventors: Charles H. Bianchi, Durham, NH (US); Nguyen D. Nguyen, Dorchester, MA (US)

(73) Assignee: Raytheon Company, Waltham, MA (US)

(21) Appl. No.: 15/452,962

(22) Filed: Mar. 8, 2017

(51) Int. Cl. G01S 13/42

(52) U.S. Cl. CPC G01S 13/42

(57) ABSTRACT

In one aspect, a method includes performing narrowband frequency domain sampling of a signal received at a sensor from a target to generate a broadband frequency response, generating a spectral signature from the broadband frequency response generated and performing an inverse Fourier Transform on the spectral signature to generate a temporal profile.

### BACKGROUND

Time domain is an analysis of functions or signals, for example, with respect to time. In the time domain, the signal or function's value is known for all real numbers, for the case of continuous time, or at various separate instants in the case of discrete time. A time-domain graph depicts how a signal changes over time.

Frequency domain is an analysis of functions or signals, for example, with respect to frequency. In one example, a frequency-domain graph depicts how much of a signal lies within each given frequency band over a range of frequencies. A frequency-domain representation can also include information on the phase shift that must be applied to each sinusoid to be able to recombine the frequency components to recover the original time signal.

### SUMMARY

In one aspect, a method includes performing narrowband frequency domain sampling of a signal received at a sensor from a target to generate a broadband frequency response, generating a spectral signature from the broadband frequency response generated and performing an inverse Fourier Transform on the spectral signature to generate a temporal profile.

In another aspect, a sensor, includes electronic hardware circuitry configured to perform narrowband frequency domain sampling of a signal received at the sensor from a target to generate a broadband frequency response, generate a spectral signature from the broadband frequency response generated and perform an inverse Fourier Transform on the spectral signature to generate a temporal profile.

In a further aspect, an article includes a non-transitory computer-readable medium that stores computer-executable instructions. The instructions causing a machine to perform narrowband frequency domain sampling of a signal received at a sensor from a target to generate a broadband frequency response, generate a spectral signature from the broadband frequency response generated and perform an inverse Fourier Transform on the spectral signature to generate a temporal profile.

### DESCRIPTION OF THE DRAWINGS

FIG. 1A is diagram of a target and a sensor in a backscatter model with two return paths

FIG. 1B is a phasor diagram of the backscatter model with two return paths in FIG. 1A.

FIG. 1C is a diagram of narrowband frequency sampling.

FIG. 2A is a block diagram of an example of a sensor to perform broadband sensing using narrowband frequency domain sampling.

FIG. 2B is a diagram of a discrete spectral signature for the backscatter model with two return paths.

FIG. 2C is a diagram of a discrete temporal profile for the backscatter model with two return paths.

FIG. 3 is a flow chart of example of a process to perform broadband sensing using narrowband frequency domain sampling.

FIG. 4 is a block diagram of an example of a computer on which the process of FIG. 3 may be implemented.

### DETAIL DESCRIPTION

Described herein are techniques to perform broadband sensing using narrowband frequency domain sampling. In one example, a discrete spectral signature may be generated using the narrowband frequency domain sampling. In one example, from the discrete spectral signature, a discrete temporal profile may be generated. From the discrete spectral signature and the discrete temporal profile features may be extracted about a target.

The discrete broadband frequency response of a target return may be obtained by narrowband frequency domain sampling of the received signal. The broadband frequency response is assembled from samples of the received power of narrower band channels separated in frequency, preferably with minimal overlap in frequency to suppress spectral correlation. The narrowband channels are sampled as closely as possible in time (if not coincident), constituting a single look, to maintain temporal correlation with respect to the movement of the back-scattering object and any variations in the transmission channel.

The resulting spectral signature will be unique to the fixed structure of the back-scattering object that is resolved by the configuration of the frequency domain sampling method. Ripple depth and spacing in a spectral signature result from variations in (and are thus indicative of) the size and spacing of the significant illuminated reflecting structures on a passive back-scattering object. Discontinuities and other non-passive distortions in a spectral signature suggest underlying variations in the broadband return signal from system performance issues or an active and responsive source.

A higher resolution time response may also be estimated from the broadband frequency response. The high-resolution time response is generated by the inverse Fourier transform of the broadband power spectrum. The resulting temporal profile will include discrete features in the time domain that are generated by the fixed structure of back-scattering object and resolved by the configuration of the frequency domain sampling method. Discrete peaks in the time magnitude response correspond to (and are thus indicative of) returns from separate illuminated reflecting structures on a passive back-scattering object. Other non-discrete distortions in the temporal profile suggest underlying discontinuities in the broadband return signal due to system performance issues or an active and responsive source.

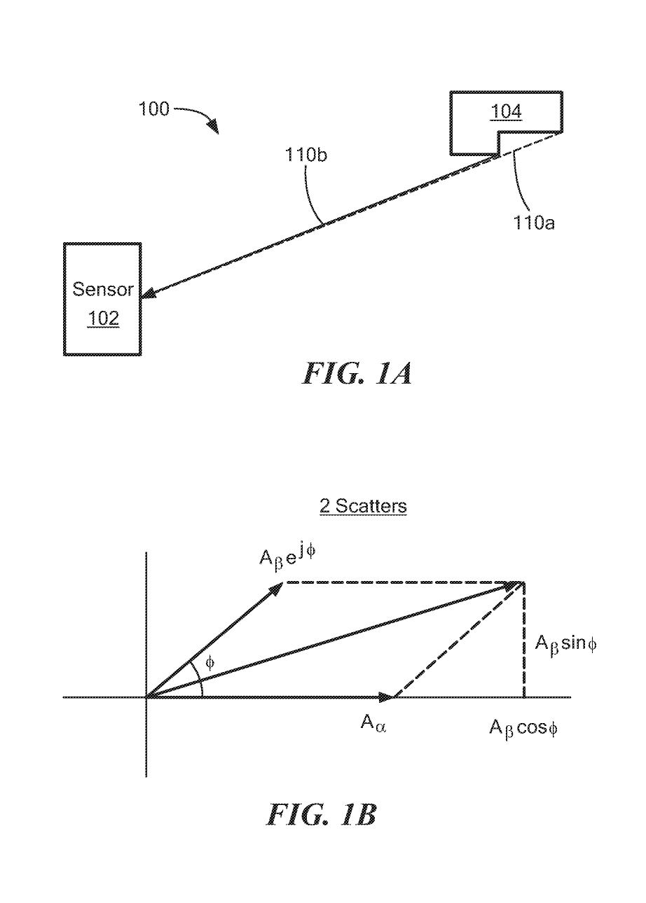

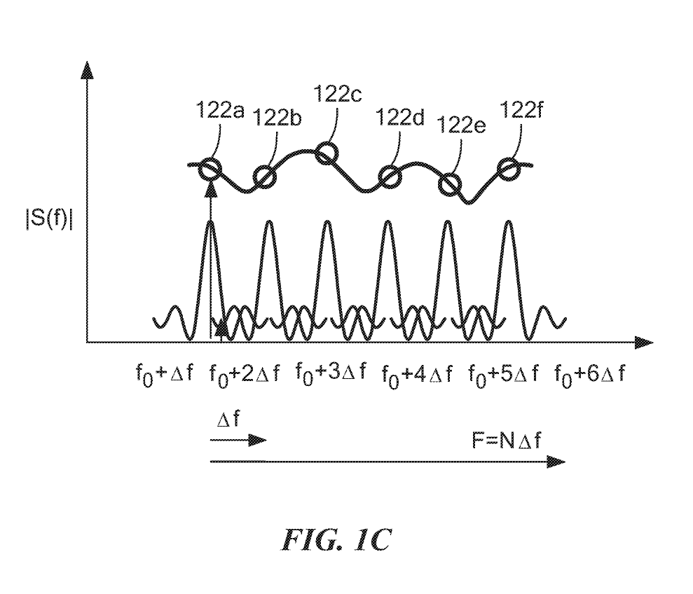

Referring to FIG. 1A, an example of a sensor to perform broadband sensing using narrowband frequency domain sampling is 102. FIG. 1A depicts a simple case, which represents a two-path discrete scattering response (DSR) model. The disclosure herein is not limited to two-path return model but may include any number of return paths. Moreover, one or more of the return paths may not be directly back to the sensor but may be, for example, indirect return paths reflected from other sources (objects or reflecting surfaces).

The sensor 102 detects a target 104 by sending a signal and receiving a return signal (sometimes called a backscatter). For example, a sensor 102 sends a signal to the target 104 and a first return signal along a return path 110a is received at the sensor 102 and a second return signal along a return path 110b is received at the sensor 102. In one example, the return paths 110a, 110b may be from different reflecting structures of the target 104, such as, for example, a nose or tail of the target 104.

The sensor 102 may be a sonogram to detect fetuses, a radar to detect flying objects, ground-penetrating radar to detect shale deposits or oil deposits, and so forth. As used herein the return paths 110a, 110b each represent a scattering path. The differential delay of two scatter returns is a function of target composition (rigid features) and therefore may only change over time because of changes in visibility and aspect angle.

FIG. 1B is a phasor diagram of FIG. 1A. The first backscatter return is represented as:

\vec{s}_{α}=αe^{j[2πfτ}^{_{α]}}

and the second backscatter return is represented as:

\vec{s}_{β}=βe^{j[2πfτ}^{_{β]}}

so

σe^{jϕ}=αe^{j[2πfτ}^{_{α]}}+βe^{j[2πfτ}^{_{β]}},

the composite return signal,

σe^{jΔϕ}=α+βe^{j[2πfτ]}

where

Δτ=τ_{β}−τ_{α}

Δϕ=ϕ−j2πfτ_{α}

and where α=amplitude of first backscatter return, τ_{α}=propagation delay of first backscatter return, β=amplitude of second backscatter return, τ_{β}=propagation delay of second backscatter return, f=frequency, and σ=the composite return amplitude.

Referring to FIG. 1C, an objective of sampling in the time domain is to maximize the integrity of the signal of interest by applying a time sampling function with time and frequency characteristics that minimize the correlation of adjacent time samples with the time sample of interest. Similarly, an objective of sampling in the frequency domain is to maximize the integrity of the response of interest by applying a frequency sampling function with frequency and time characteristics that minimize the correlation of adjacent frequency samples with the frequency sample of interest.

Sampling in the frequency domain provides a basis for efficient expansion of the effective bandwidth of a sensing system. The broadband response of a channel may be assembled from samples 122a-122f of narrower band channels. In this example, the sample 122a is taken at f₀+Δf, the sample 122b is taken at f0+2Δf, the sample 122c is taken at f0+3Δf, the sample 122d is taken at f₀+4Δf, the sample 122e is taken at f₀+5Δf and the sample 122f is taken at f₀+6Δf, where f is frequency. The broadband bandwidth is equal to NΔf, where N is the number of samples. The corresponding time window is 1/Δf and the time resolution Δt is 1/(NΔf). The sampling function is narrow in frequency but broad in time.

In one example, in selecting the narrowband channels, one may consider that the narrowband channels should have sufficient separation in frequency (minimum spectral overlap) to minimize adjacent narrowband channel coupling. Also, the narrowband channel samples 122a-122f should have minimal separation in sample time across the total bandwidth (optimum coincidence with respect to the time response of channel dynamics) to retain the correlation of the narrowband channel samples and maintain the integrity of a single broadband look at the response of interest.

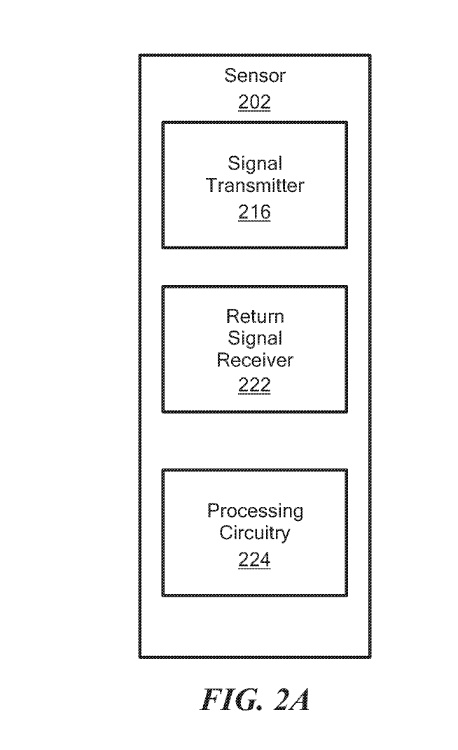

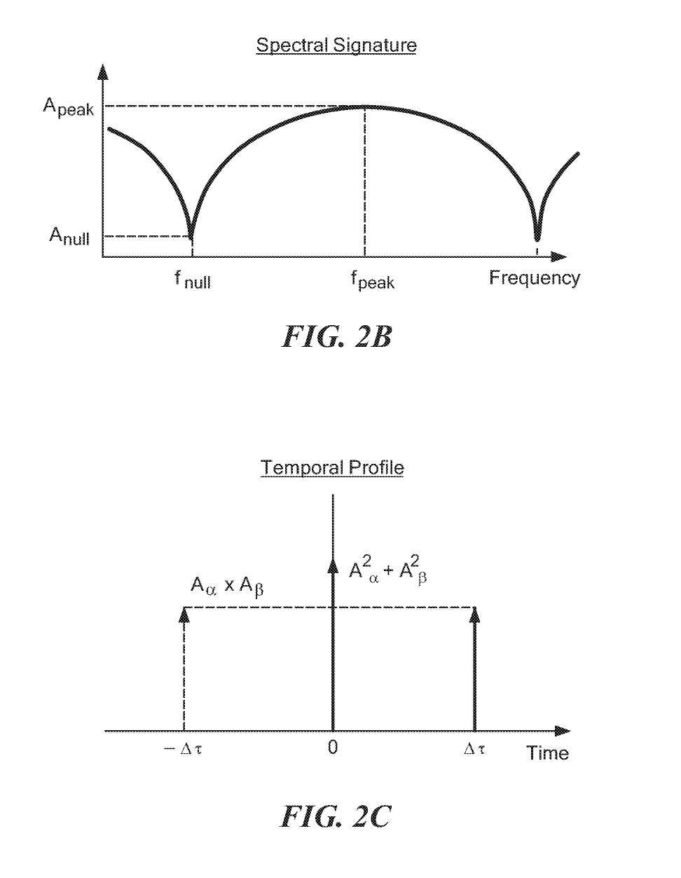

Referring to FIG. 2A, an example of a sensor 102 is the sensor 202. The sensor 202 includes a signal transmitter 216 to send the signal to the target 104, a return signal receiver 22 to receive the return signal from the target (including the back scattering paths) and the processing circuitry 224 to perform narrowband sampling of the returned signal to generate the broadband response. The processing circuitry 224 generates the discrete spectral signature and the discrete temporal profile from the generated broadband response.

Referring to FIG. 2B, a discrete spectral signature may be generated by taking frequency sampling of magnitude (amplitude or power) of the return signal. In one example, a spectral response of the two-path DSR may be expressed as:

$$\begin{matrix}\vert {\vec{s}}_{α , β} {e}^{- j [ 2 π f {τ}_{α} ]} {\vert}^{2} = \vert {A}_{α} + {A}_{β} {e}^{j φ} {\vert}^{2} \\ = {( {A}_{α} + {A}_{β} cos φ )}^{2} + {( {A}_{β} sin φ )}^{2} \\ = {A}_{α}^{2} + {A}_{β}^{2} + 2 {A}_{α} {A}_{β} cos φ\end{matrix}$$

A frequency peak, fₚₑₐₖ occurs at Aₚₑₐₖ where:

$${A}_{peak} = α + β$$

$${A}_{peak} when 2 π f ( {τ}_{β} - {τ}_{α} ) - 2 π f = 2 n π$$

$$Or {f}_{peak} = \frac{n}{( {τ}_{β} - {τ}_{α} - 1 )}$$

A frequency null, fₙᵤₗₗ occurs at Aₙᵤₗₗ where:

$${A}_{null} = α - β$$

$${A}_{null} when 2 π f ( {τ}_{β} - {τ}_{α} ) - 2 π f = n π$$

$$Or {f}_{null} = \frac{n}{2 ( {τ}_{β} - {τ}_{α} - 1 )}$$

Since the null positions are a function of the differential path delay, the null positions are stable for returns from stationary objects with multiple fixed scattering surfaces.

Observable dimensions of the fixed structure of the back-scattering object that are resolvable by the number of frequency domain samples (sub-channels of the broadband or narrowband channels) and the overall frequency span of the process (broadband bandwidth) may be estimated from the spectral signature. In the case of the spectral signature, a multi-scatter channel model and a polynomial approximation to the broadband frequency response are both solved simultaneously near a local spectral minimum (ripple null) to estimate the separation in time of the reflecting structures and the relative strength of the superimposed returns. The separation in time is then converted to distance to estimate the relative location of the reflecting structures. This technique may be applied for solution to a subset of samples at or near each local minimum to estimate all resolvable features. An absence of structure suggests non-resolvable features or a single point scatter return. Atypical results are indicative of anomalous propagation and back-scatter or interference.

Referring to FIG. 2C, a discrete temporal profile may be generated by taking an inverse Fourier Transform of the spectral signature. In one example, a spectral response of the two-path DSR may be expressed as:

A_{α}²+A_{β}²+2A_{α}A_{β}cos ϕ=A_{α}²+A_{β}²+2A_{α}A_{β}cos 2πr fΔτ.

Taking the inverse Fourier Transform yields:

ℑ{A_{α}²+A_{β}²+2A_{α}A_{β}cos 2πfΔτ}=(A_{α}²+A_{β}²)δ(t)+A_{α}A_{β}δ(t+Δτ)+A_{α}A_{β}δ(t−Δτ),

which is illustrated in FIG. 2C. The constructed temporal profile for a two-path DSR shows impulse responses at −Δτ, 0 and Δτ, where Δτ is the propagation delay difference of the two return paths.

Observable dimensions of the fixed structure of the back-scattering object that are resolvable by the number of frequency domain samples (sub-channels of the broadband or narrowband channels) and the overall frequency span of the process (broadband bandwidth) may be estimated from the temporal profile. In the case of the temporal profile, discrete peaks are located in magnitude, and the relative strength of each and position in time are computed and converted to distance in order to determine the relative location of the reflecting structures. An absence of discrete peaks suggests non-resolvable features or a single point scatter return. An abundance of peaks is indicative of anomalous propagation and back-scatter or interference.

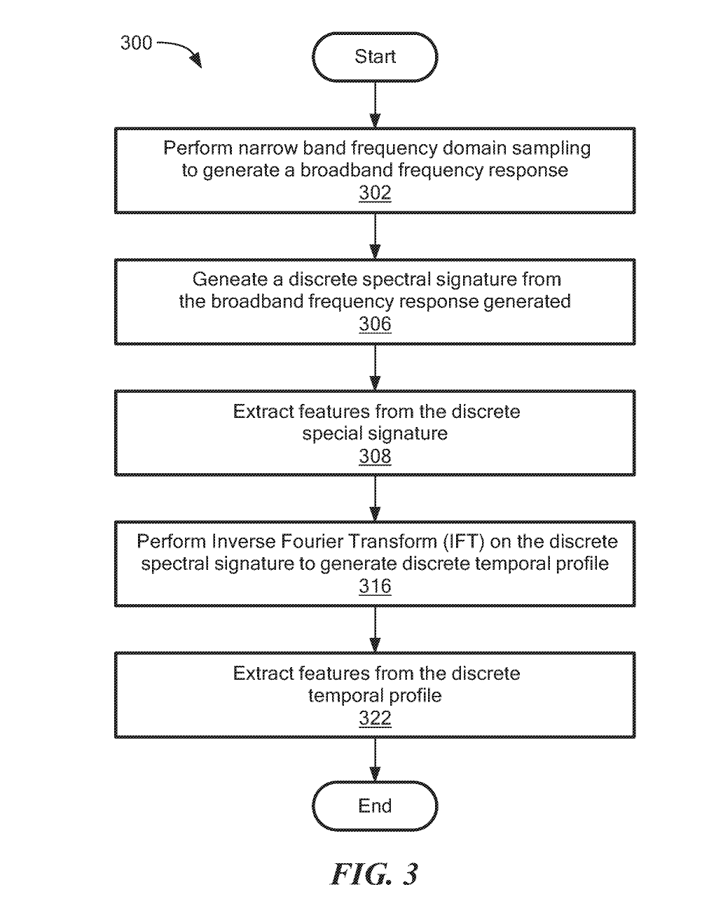

Referring to FIG. 3, an example of a process to perform broadband sensing using narrowband frequency domain sampling is a process 300. Process 300 performs narrowband frequency domain sampling of a received signal to generate a broadband frequency response (302).

Process 300 generates a discrete spectral signature from the broadband frequency response generated (308). Process 300 extracts features from the discrete spectral signature (308). For example, the distance separating multiple reflecting structures may be determined. In another example, a broadband spectral response may be characterized (shape, bandwidth). In another example, the difference in distance of primary (direct) and secondary (indirect) returns from the same object may be determined.

Process 300 performs an inverse Fourier Transform (IFT) on the discrete spectral signature to generate a discrete temporal profile (316). Process 300 extracts features from the discrete temporal profile (322). For example, the time separating multiple reflecting structures may be determined. In another example, a broadband time response may be characterized (delay spread or distribution). In another example, the difference in time of primary (direct) and secondary (indirect) returns from the same object may be determined.

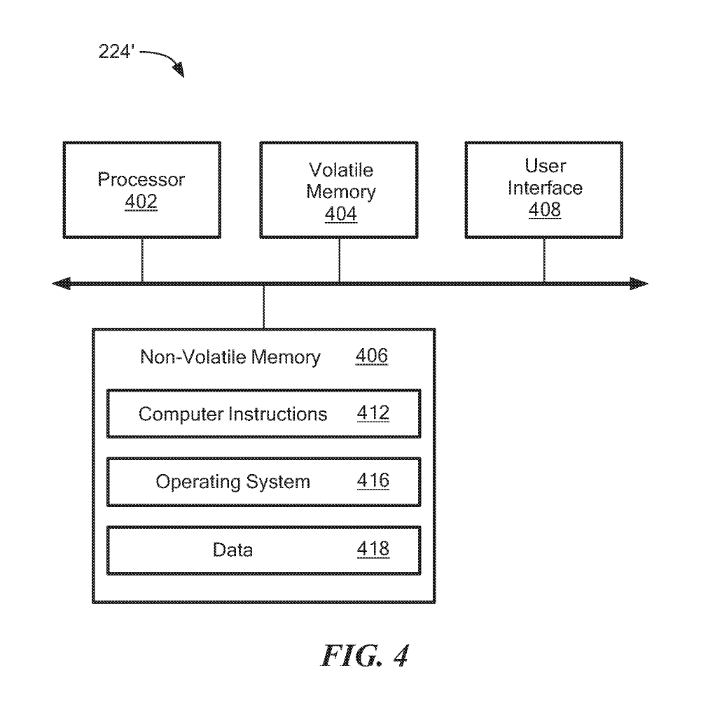

Referring to FIG. 4, one example of the processing circuitry 224 is the processing circuitry 224′. The processing circuitry 224 includes a processor 402, a volatile memory 404, a non-volatile memory 406 (e.g., hard disk) and the user interface (UI) 408 (e.g., a graphical user interface, a mouse, a keyboard, a display, touch screen and so forth). The non-volatile memory 406 stores computer instructions 412, an operating system 416 and data 418. In one example, the computer instructions 412 are executed by the processor 402 out of volatile memory 404 to perform all or part of the processes described herein (e.g., process 300).

The processes described herein (e.g., process 300) are not limited to use with the hardware and software of FIG. 4; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). Each such program may be implemented in a high level procedural or object-oriented programming language to work with the rest of the computer-based r system. However, the programs may be implemented in assembly, machine language, or Hardware Description Language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

The processes described herein are not limited to the specific examples described. For example, the process 300 is not limited to the specific processing order of FIG. 3. Rather, any of the processing blocks of FIG. 3 may be re-ordered, combined or removed, performed in parallel or in serial, as necessary, to achieve the results set forth above.

The processing blocks (for example, in the process 300) associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, programmable logic devices or logic gates.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method, comprising:
performing narrowband frequency domain sampling of a signal received at a sensor from a target to generate a broadband frequency response;
generating a spectral signature from the broadband frequency response generated; and
performing an inverse Fourier Transform on the spectral signature to generate a temporal profile.

2. The method of claim 1, further comprising extracting a feature of the target from the discrete spectral signature.

3. The method of claim 1, further comprising extracting a feature of the target from the discrete temporal profile.

4. The method of claim 1, wherein a signal in a narrowband channel in the frequency sampling has less than 5% overlap with signal in other narrowband channels.

5. The method of claim 4, wherein the signal in narrowband channel has no overlap with the signals in other narrowband channels.

6. The method of claim 4, wherein performing narrowband frequency domain sampling of a signal received at a sensor from a target to generate a broadband frequency response comprises performing narrowband frequency domain sampling of a signal received at a radar.

7. A sensor, comprising:
electronic hardware circuitry configured to:
perform narrowband frequency domain sampling of a signal received at the sensor from a target to generate a broadband frequency response;
generate a spectral signature from the broadband frequency response generated; and
perform an inverse Fourier Transform on the spectral signature to generate a temporal profile.

8. The apparatus of claim 7, wherein the circuitry comprises at least one of a processor, a memory, a programmable logic device or a logic gate.

9. The apparatus of claim 7, further comprising circuitry configured to extract a feature of the target from the discrete spectral signature.

10. The apparatus of claim 7, further comprising circuitry configured to extract a feature of the target from the discrete temporal profile.

11. The apparatus of claim 7, wherein a signal in a narrowband channel in the frequency sampling has less than 5% overlap with signal in other narrowband channels.

12. The apparatus of claim 11, wherein the signal in narrowband channel has no overlap with the signals in other narrowband channels.

13. The apparatus of claim 11, wherein the circuitry configured to perform narrowband frequency domain sampling of a signal received at a sensor from a target to generate a broadband frequency response comprises circuitry configured to perform narrowband frequency domain sampling of a signal received at a radar.

14. An article comprising:
a non-transitory computer-readable medium that stores computer-executable instructions, the instructions causing a machine to:
perform narrowband frequency domain sampling of a signal received at a sensor from a target to generate a broadband frequency response;
generate a spectral signature from the broadband frequency response generated; and
perform an inverse Fourier Transform on the spectral signature to generate a temporal profile.

15. The article of claim 14, further comprising circuitry configured to extract a feature of the target from the discrete spectral signature.

16. The article of claim 14, further comprising circuitry configured to extract a feature of the target from the discrete temporal profile.

17. The article of claim 14, wherein a signal in a narrowband channel in the frequency sampling has less than 5% overlap with signal in other narrowband channels.

18. The article of claim 17, wherein the signal in narrowband channel has no overlap with the signals in other narrowband channels.

19. The apparatus of claim 17, wherein the circuitry configured to perform narrowband frequency domain sampling of a signal received at a sensor from a target to generate a broadband frequency response comprises circuitry configured to perform narrowband frequency domain sampling of a signal received at a radar.
